(19) United States
(12) Patent Application Publication
(10) Pub. No.: US 2005/0202265 A1
(43) Pub. Date: Sep. 15, 2005

(54) Gas barrier film

(75) Inventors: Hideaki Naruse, Minami-ashigara-shi (JP); Seiya Sakurai, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/060,378

(22) Filed: Feb. 17, 2005

(30) Foreign Application Priority Data
Feb. 17, 2004 (JP) 2004-039324

(51) Int. Cl. B32B 5/16; B32B 27/00

(52) U.S. Cl. 428/500; 428/323; 428/328

(57) ABSTRACT

A gas barrier film having an alternate laminate comprising at least one barrier layer comprising an inorganic substance and at least one organic layer and at least one moisture absorbing layer on a thermoplastic support, wherein the laminate shows a water vapor permeability of 0.005 g/m²·day or lower at 25° C. and 75% RH. A gas barrier film having ultrahigh gas barrier performance and an organic EL device utilizing the gas barrier film having superior durability and flexibility are provided.

### BACKGROUND OF THE INVENTION

1. Field of the Invention

The present invention relates to a gas barrier film having superior gas barrier performance and an organic electroluminescence device (henceforth referred to as “organic EL device”) utilizing the gas barrier film. More precisely, the present invention relates to a gas barrier film having extremely superior gas barrier performance and suitable as a substrate of various kinds of devices or suitable for coating a substrate and an organic EL device utilizing the gas barrier film and showing superior durability and flexibility.

2. Description of the Related Art

Currently, gas barrier films prepared by forming a thin film of metal oxide such as aluminum oxide, magnesium oxide or silicon oxide on a surface of a plastic substrate or film have been widely used in packaging of articles which require shielding of various gases such as water vapor and oxygen, and packaging use for preventing deterioration of food, industrial materials, medical supplies and so forth. In addition to the packaging use, gas barrier films are also used in liquid crystal display devices, solar cells, substrates for electroluminescence (EL) devices and so forth.

Transparent base materials, of which applications for liquid crystal display devices, EL devices and so forth are spreading in recent years, are needed to satisfy highly sophisticated requirements in addition to the needs of lighter weight and larger sizes. For example, they must have long-term reliability and higher degree of freedom of the shape, they must enable display on a curved surface, ard so forth. As transparent base materials that satisfy such sophisticated requirements, adoption of plastic base materials is studied as an alternative to conventional glass substrates, which are heavy, readily broken and difficult to be formed in a larger size. Transparent plastic films not only satisfy the aforementioned requirements, but also show more favorable productivity compared with glass substrates because a roll-to-roll system can be used for them, and therefore they are more advantageous also in view of cost reduction. However, film base materials of transparent plastics etc. have a drawback that their gas barrier property is inferior to that of glass base materials. If a base material having poor gas barrier property is used, water vapor and air permeate the material to, for example, degrade liquid crystals in a liquid crystal cell, form display defects and thereby degrade display quality. As materials that solve this problem, gas barrier film base materials in which a metal oxide thin film is formed on a film substrate have been known so far.

As gas barrier films used for packaging materials or liquid crystal display devices, those comprising a plastic film on which silicon oxide is vapor-deposited (Japanese Patent Publication (Kokoku) No. 53-12953) and those comprising a plastic film on which aluminum oxide is vapor-deposited (see, for example, Japanese Patent Laid-open Pub ication (Kokai) No. 58-217344, claims and Example 1) are known. These films have a water vapor permeability of about 1 g/m²/day. However, due to production of liquid crystal displays of larger size and development of high precision displays, gas barrier performance of film substrates is even required to satisfy gas barrier performance of about 0.1 g/m²/day in terms of water vapor permeability property in recent years.

Furthermore, development of organic EL displays, high precision color liquid crystal displays and so forth has progressed in recent days, which require further higher gas barrier property, and therefore base materials satisfying performances of maintaining usable transparency and having higher barrier performance, in particular, barrier performance of less than 0.1 g/m₂/day in terms of water vapor permeability, have come to be required. In order to meet such demands, studied is film formation by the sputtering method or CVD method as a means that can be expected to provide higher barrier performance, in which a thin film is formed by using plasma generated by glow discharge under a low pressure condition. Moreover, techniques of preparing a barrier film having an alternate laminate structure of organic layers and inorganic layers by the vacuum deposition method are proposed in U.S. Pat. No. 6,413,645 B1, claims and FIG. 1; and Thin Solid Film, pp. 290-291 (1996).

However, in these methods for forming a thin film described in these documents, an organic substance blown as vapor of high temperature condenses on a film and form a thin film, and therefore the film is temporarily heated and causes partial deformation. As a result, the subsequent lamination step becomes uneven, and thus the methods have a problem that they cannot provide sufficient barrier ability. Moreover, invasion of a trace amount of moisture Into devices with time cannot be prevented even by using these methods, and it constitutes a major factor of inhibiting realization of longer lifetime of organic EL devices, which are likely to be affected by external environments.

As described above, although it has been desired to develop a technique of obtaining both of durability and lighter weight of organic EL devices by using plastic substrates, which can realize a markedly lighter weight compared with conventional glass substrates, such a technique has not been developed yet.

### SUMMARY OF THE INVENTION

The present invention was accomplished in order to solve the aforementioned problems, and an object of the present invention is to provide a gas barrier film that exhibits superior gas barrier performance applicable to image display devices such as organic EL devices.

Another object of the present invention is to provide an organic EL device having superior durability utilizing the gas barrier film of the present invention as a substrate.

The inventors of the present invention conducted various researches in order to develop a gas barrier film showing superior gas barrier performance, in particular, extremely low water vapor permeability, and finally achieved the present invention.

That is, the objects of the present invention are achieved by the gas barrier film and organic EL device of the present invention having the following configurations.

(1) A gas barrier film having (1) a laminate alternately comprising at least one barrier layer comprising an inorganic substance and at least one organic layer and (2) at least one moisture absorbing layer on a thermoplastic support, wherein the laminate shows a water vapor permeability of 0.005 g/m²·day or lower at 25° C. and 75% RH.

(2) The gas barrier film according to (1), wherein the moisture absorbing layer is a layer comprising particles of a metal compound consisting of at least one kind of particles selected from CaO, SrO, BaO and MgO particles having a diameter of 1 to 100 nm as sphere.

(3) The gas barrier film according to (1) or (2), wherein the moisture absorbing layer shows a thickness change of 3 nm or less after moisture absorption.

(4) The gas barrier film according to any one of (1) to (3), wherein the organic layer is an organic-inorganic hybrid layer or a layer obtained by ring-opening polymerization of monomers having an oxetane group.

(5) The gas barrier film according to any ore of (1) to (4), wherein the thermoplastic support is formed with a polymer having a glass transition temperature of 250° C. or higher.

(6) An organic electroluminescence device, which utilizes the gas barrier film according to any one of (1) to (5) as a substrate.

The gas barrier film of the present invention has a laminate alternately comprising a barrier layer and an organic layer, and a moisture absorbing layer. The present invention thus can provides a gas barrier film having superior gas barrier performance suitable for a substrate of various devices or for coating substrates.

The organic EL device of the present invention utilizes the gas barrier film of the present invention as a substrate, and therefore an organic EL device that can effectively prevent invasion of moisture into the inside of devices even under a high humidity environment and thus shows superior durability and flexibility can be provided.

### BRIEF EXPLANATION OF THE DRAWING

FIG. 1 is a schematic explanatory view of the roll-to-roll type sputtering apparatus used in Example 1. The sputtering apparatus 1 comprises a vacuum chamber 2, drum 3, feeding roller 4, rolling-up roller 5, plastic film (support) 6, guide roller 7, guide roller 8, exhaust ports 9, vacuum pumps 10, electric discharge power source 11, cathode 12, controller 13, gas flow rate control unit 14, and reactive gas piping 15.

### BEST MODE FOR CARRYING OUT THE INVENTION

Hereafter, the gas barrier film of the present invention and an organic EL device utilizing the film will be explained in detail.

The ranges expressed with “to” in the present specification mean ranges including the numerical values indicated before and after “to” as a lower limit value and upper limit value.

[Gas Barrier Film]

<Thermoplastic Support>

The material of the thermoplastic support used for the gas barrier film of the present invention (referred to with an abbreviation of “support” hereinafter) is not particularly limited so long as the material formed in the shape of film can hold the laminate, and a material usable as a base material for gas barrier films can be suitably selected. Examples of such materials include, for example, thermoplastic resins such as methacrylic resins, methacrylic acid/maleic acid copolymers, polystyrenes, transparent fluoro-resins, polyimide resins, fluorinated polyimide resins, polyamide resins, polyamidimide resins, polyetherimide resins, cellulose acylate resins, polyurethane resins, polyether ether ketone resins, polycarbonate resins, alicyclic polyolefin resins, polyarylate resins, polyether sulphone resins, polysulfone resins, cycloolefin copolymers, fluorene ring-modified polycarbonate resins, alicyclic ring-modified polycarbonate resins and acryloyl compounds.

The polymer constituting the support preferably has a glass transition temperature (henceforth referred to as “Tg”) of 250° C. or higher, more preferably 300° C. or higher, still more preferably 350° C. or higher, in view of heat resistance. Although Tg of the aforementioned polymer is not particularly limited as for the upper limit thereof, it is suitably 700° C. or lower, preferably 650° C. or lower, if ease of polymer synthesis, availability of the material and so forth are taken into account.

Preferred examples of the polymer having Tg of 250° C. or higher used for the support include polymers having a spiro structure represented by the following formula (1) and polymers having a cardo structure represented by the following formula (2). These polymers are compounds showing high heat resistance, high elastic modulus and high tension fracture stress and suitable as support materials for organic EL devices and so forth, for which various heating operations are required in the production processes and performance of being unlikely to fracture even when the devices are bent is required.

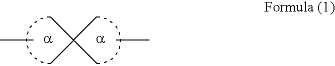

In the formula (1), the rings ,, represent a monocyclic or polycyclic ring, and two of the rings may be identical or different and are bound via a spiro bond.

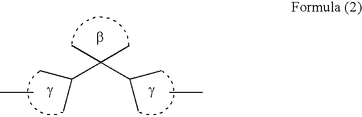

In the formula (2), the ring ,, and the rings ,, each independently represent a monocyclic or polycyclic ring, and two of the rings ,, may be identical or different and bond to one quaternary carbon atom in the ring ,,.

Preferred examples of the resins having a spiro structure represented by the formula (1) include polymers containing a spirobiindane structure represented by the following formula (3) in repeating units, polymers containing a spirobichroman structure represented by the following formula (4) in repeating units, and polymers containing a spirobibenzofuran structure represented by the following formula (5) in repeating units.

Preferred examples of the resins having a cardo structure represented by the formula (2) include polymers containing a fluorene structure represented by the following formula (6)-n repeating units.

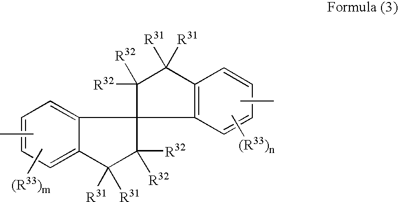

In the formula (3), R³¹ and R³² each independently represent hydrogen atom or a substituent and R³³ represents a substituent. Groups of each type may bond to each other to form a ring. m and n each independently represent an integer of 0 to 3. Preferred examples of the substituent include a halogen atom, an alkyl group and an ary_group. More preferred examples of R³¹ and R³² are hydrogen atom, methyl group and phenyl group, and more preferred examples of R³³ are chlorine atom, bromine atom, methyl group, isopropyl group, t-butyl group and phenyl group.

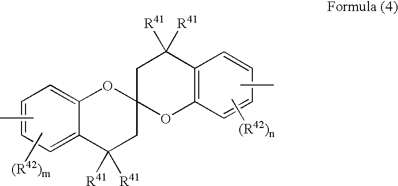

In the formula (4), R⁴¹ represents hydrogen atom or a substituent and R⁴² represents a substituent. Groups of each type may bond to each other to form a ring. m and n each independently represent an integer of 0 to 3. Preferred examples of the substituent include a halogen atom, an alkyl group and an aryl group. More preferred examples of R⁴¹ are hydrogen atom, methyl group and phenyl group, and more preferred examples of R⁴² are chlorine atom, bromine atom, methyl group, isopropyl group, t-butyl group and phenyl group.

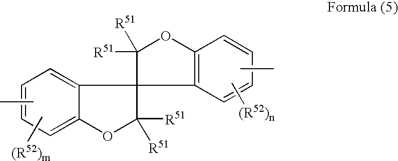

In the formula (5), R⁵¹ represents hydrogen atom or a substituent and R⁵² represents a substituent. Groups of each type may bond to each other to form a ring. m and n each independently represent an integer of 0 to 3. Preferred examples of the substituent include a halogen atom, an alkyl group and an aryl group. More preferred examples of R⁵¹ are hydrogen atom, methyl group and phenyl group, and more preferred examples of R⁵² are chlorine atom, bromine atom, methyl group, isopropyl group, t-butyl group and phenyl group.

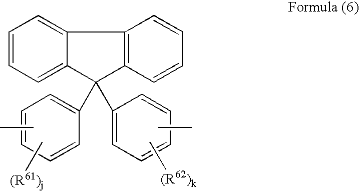

In the formula (6), R⁶¹ and R⁶² each independently represent a substituent. Groups of each type may bond to each other to form a ring. j and k each independently represent an integer of 0 to 4. Preferred examples of the substituent include a halogen atom, an alkyl group and an aryl group. More preferred examples of R⁶¹ and R⁶² are chlorine atom, bromine atom, methyl group, isopropyl group, t-butyl group and phenyl group.

The polymers containing a structure represented by any one of the formulas (3) to (6) in repeating units may be polymers formed with various bonding schemes such as polycarbonates, polyesters, polyamides, polyimides and polyurethanes. However, the polymers are preferably polycarbonates, polyesters or polyurethane derived from a bisphenol compound having a structure represented by any one of the formulas (3) to (6) in view of optical transparency. Among these, aromatic polyesters are particularly preferred in view of heat resistance.

Preferred specific examples of the polymers having a structure represented by the formula (1) or formula (2) are shown below. However, the present invention is not limited to these.

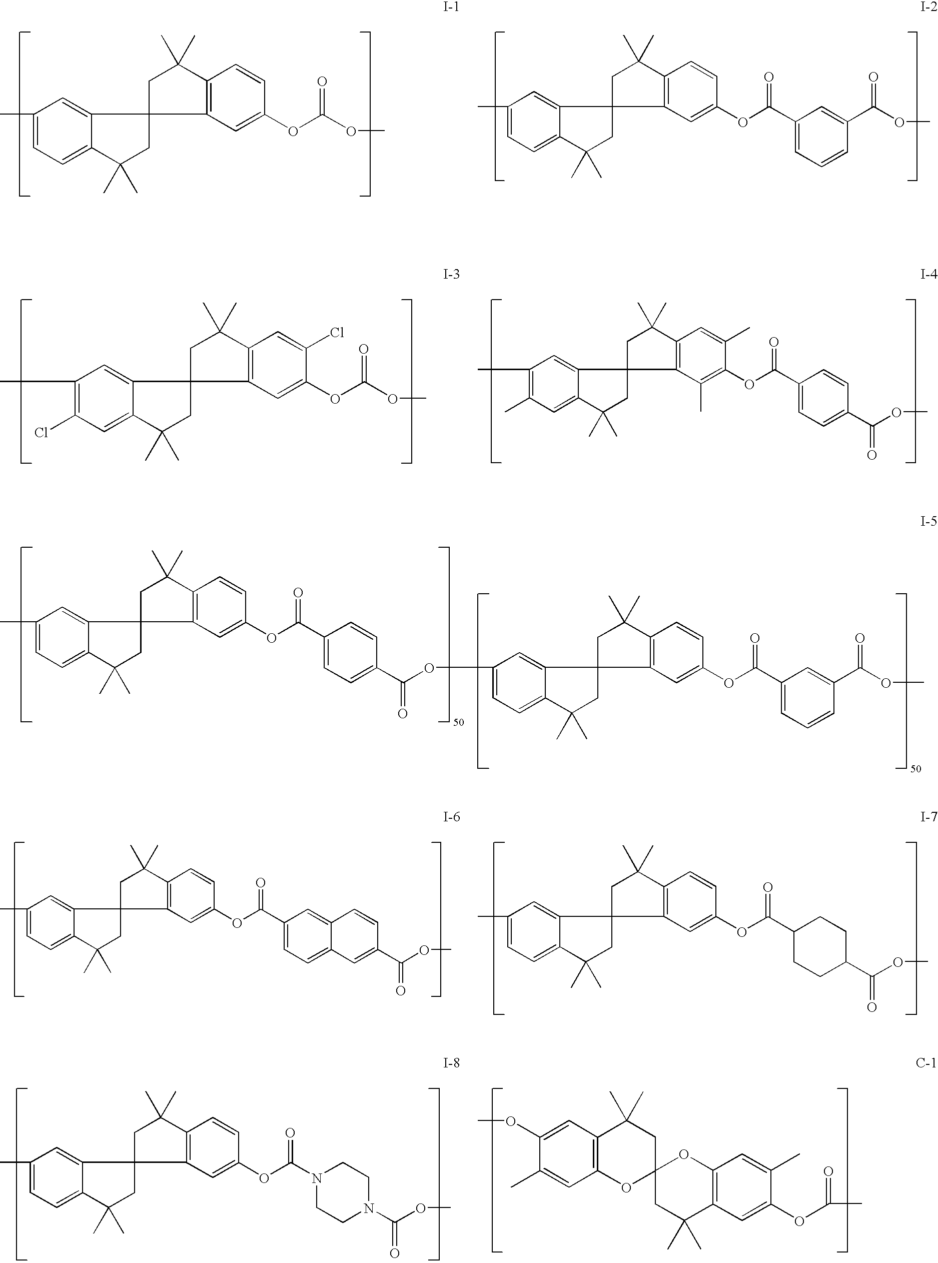

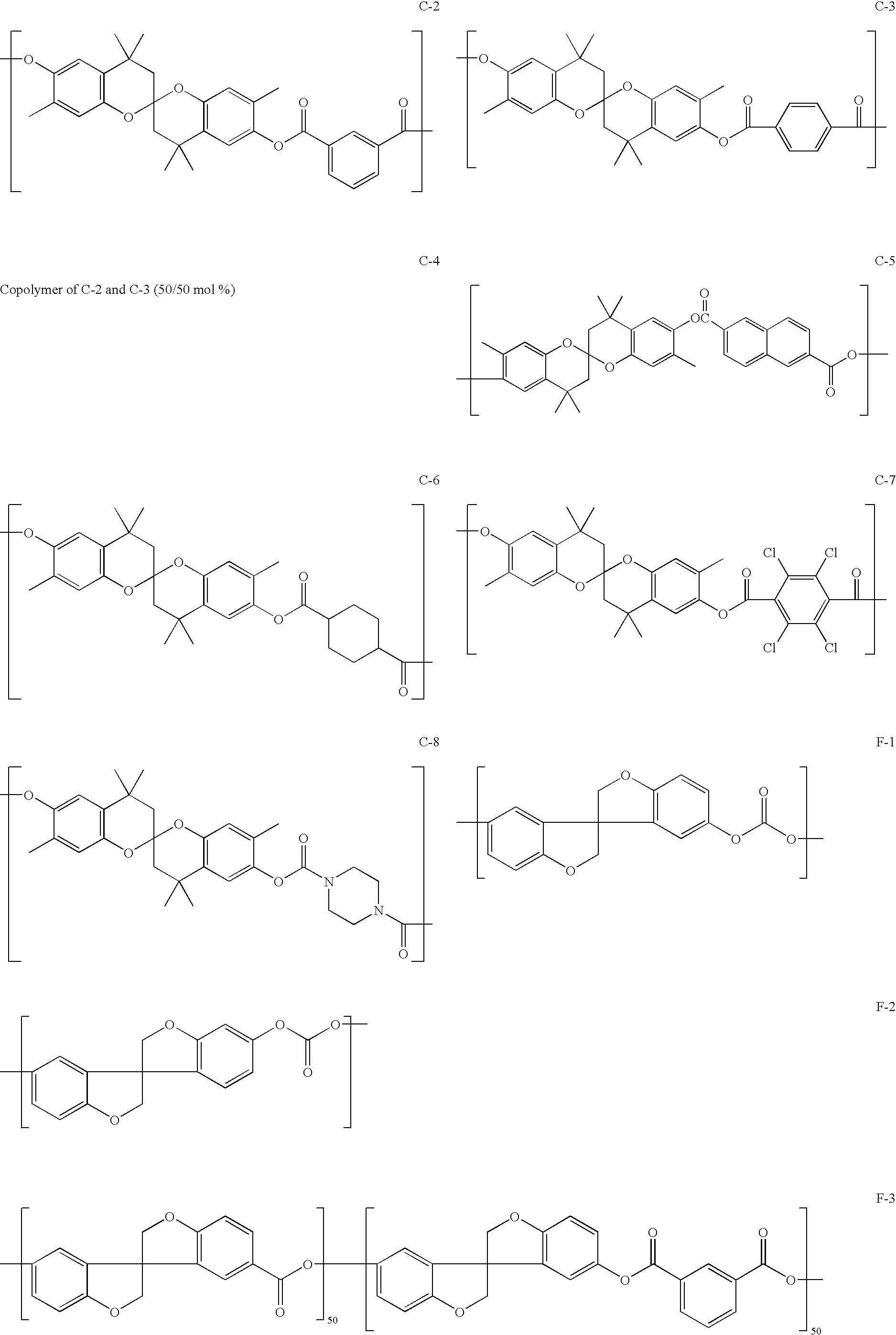

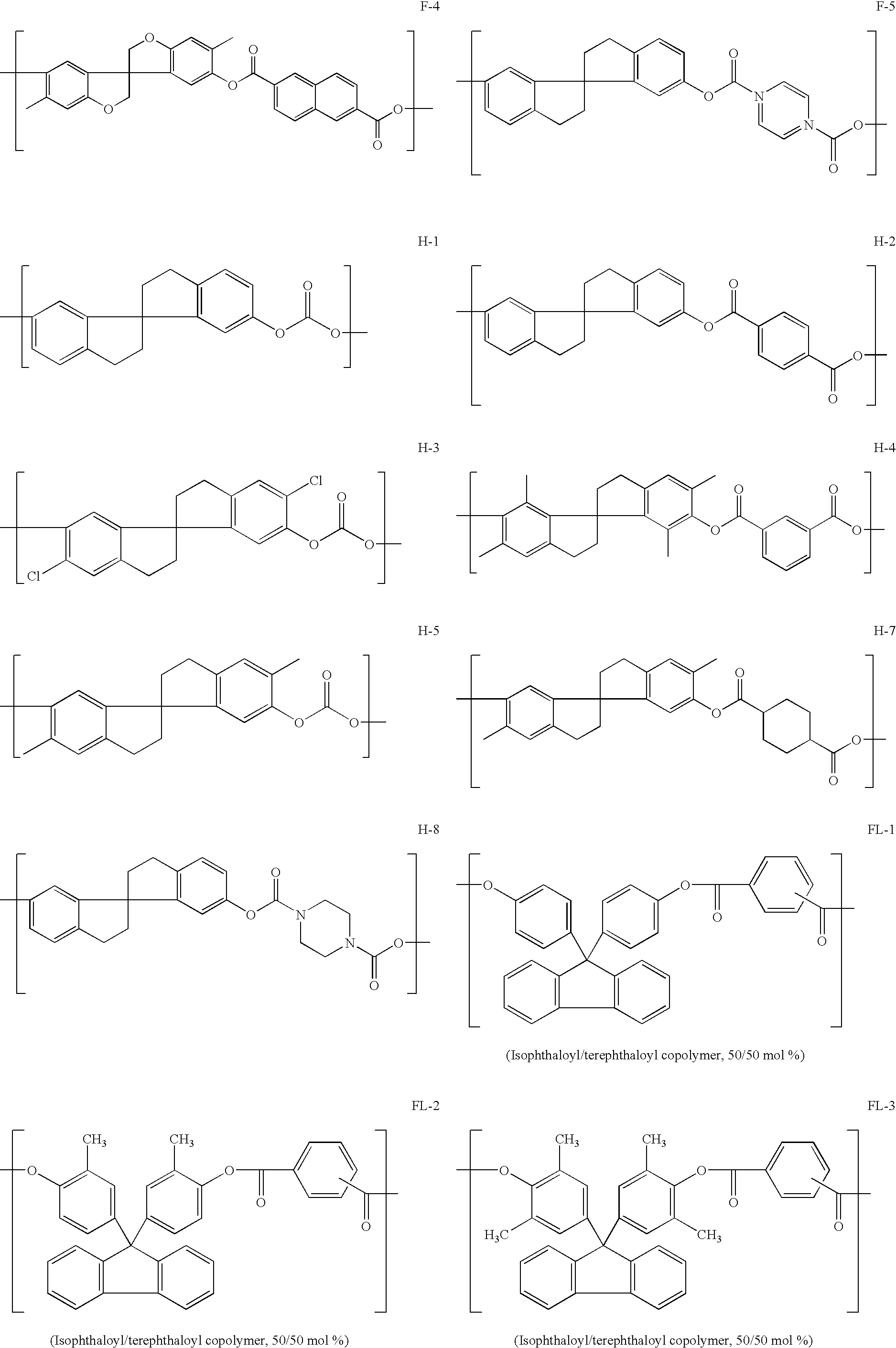

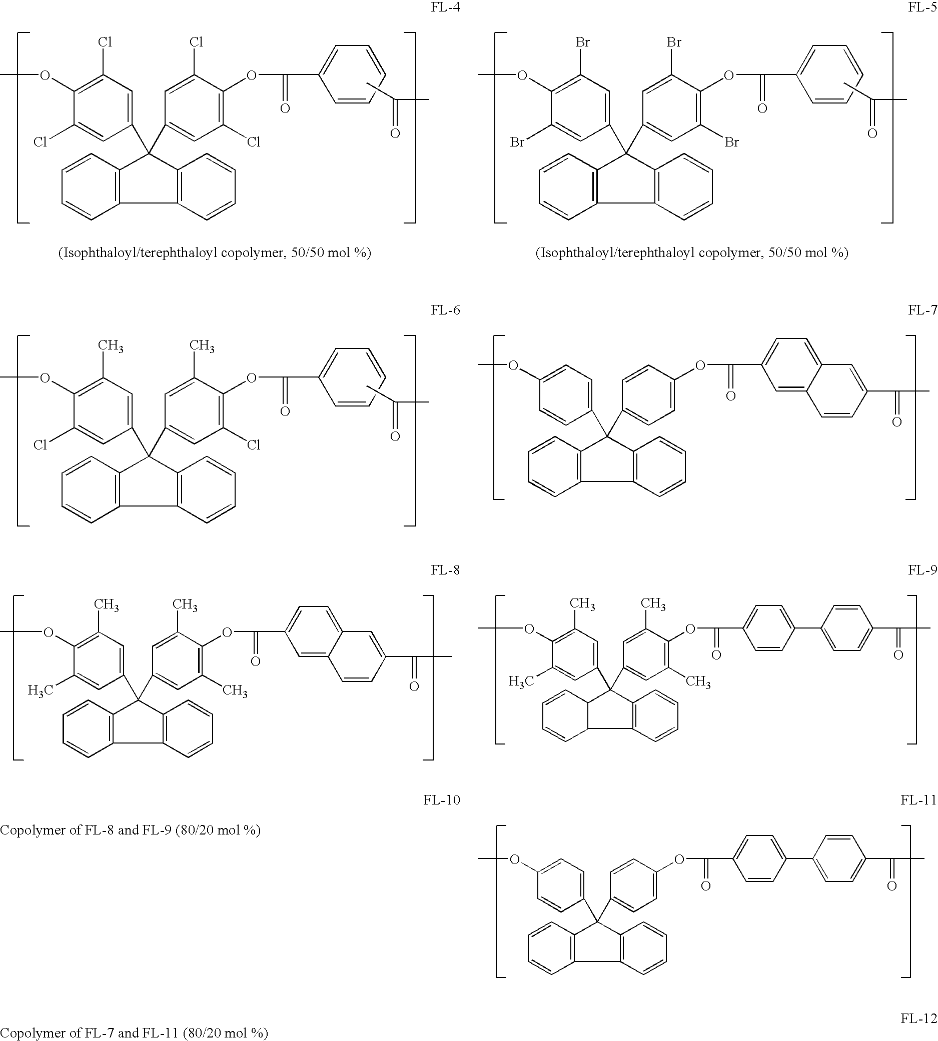

The polymers having a structure represented by the formula (1) or formula (2) used in the present invention may be used independently, and may be used as a mixture of two or more kinds of them. Moreover, they may be homopolymers or copolymers comprising a combination of two or more kinds of the structures. When a copolymer is used, a known repeating unit not containing a structure represented by the formula (1) or (2) in the repeating unit may be copolymerized within such a degree that the advantages of the present invention should not be degraded. Copolymers more often have improved solubility and transparency compared with homopolymers, and such copolymers can be preferably used.

The polymers having a structure represented by the formula (1) or formula (2) used for the present invention preferably has a molecular weight of 10,000 to 500,000, more preferably 20,000 to 300,000, particularly preferably 30,000 to 200,000, in terms of weight average molecular weight. If the molecular weight is 10,000 or more, a film can be easily formed. On the other hand, if the molecular weight is 500,000 or less, the molecular weight is easily controlled during the synthesis, favorable viscosity of a solution can be obtained, and thus handling is easy. The molecular weight may be tentatively determined on the basis of corresponding viscosity.

In the present invention, as the material used for the support, curable resins (crosslinkable resins) having superior solvent resistance, heat resistance and so forth may also be used, in addition to the aforementioned resins and polymers. As for the types of the curable resins, both of thermosetting resins and radiation curable resins can be used, and those of known types can be used without particular limitations. Examples of the thermosetting resins include phenol resins, urea resins, melamine resins, unsaturated polyester resins, epoxy resins, silicone resins, diallyl phthalate resins, furan resins, bismaleimide resins, cyanate resins and so forth.

As for the method for crosslinking the aforementioned curable resins, any reactions that form a covalent bond may be used without any particular limitation, and systems in which the reactions proceed at room temperature, such as those utilizing a polyhydric alcohol compound and a polyisocyanate compound to form urethane bonds, can also be used without any particular limitation. However, such systems often have a problem concerning the pot life before the film formation, and therefore such systems are usually used as two-pack systems, in which, for example, a polyisocyanate compound is added immediately before the film formation. On the other hand, if a one-pack system is used, it is effective to protect functional groups to be involved in the crosslinking reaction, and such systems are marketed as blocked type curing agents.

Known as the marketed blocked type curing agents are B-882N produced by Mitsui Takeda Chemicals, Inc., Coronate 2513 produced by NIPPON POLYURETHANE INDUSTRY CO., LTD. (these are blocked polyisocyanates), Cymel 303 produced by Mitsui-Cytec Ltd. (methylated melamine resin) and so forth. Moreover, blocked carboxylic acids, which are protected polycarboxylic acids usable as curing agents of epoxy resins, such as B-1 mentioned below are also known.

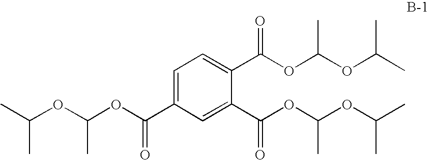

The radiation curable resins are roughly classified into radical curable resins and cationic curable resins. As a curable component of the radical curable resins, a compound having two or more radically polymerizable groups in the molecule is used, and as typical examples, compounds having 2 to 6 acrylic acid ester groups in the molecule called polyfunctional acrylate monomers, and compounds having two or more acrylic acid ester groups in the molecule called urethane acrylates, polyester acrylates, and epoxy acrylates are used.

Typical examples of the method for curing radical curable resins include a method of irradiating an electron ray and a method of irradiating an ultraviolet ray. In the method of irradiating an ultraviolet ray, a polymerization initiator that generates a radical by ultraviolet irradiation is usually added. If a polymerization initiator that generates a radical by heating is added, the resins can also be used as thermosetting resins.

As a curable component of the cationic curable resins, a compound having two or more cationic polymerizable groups in the molecule is used. Typical examples of the curing method include a method of adding a photoacid generator that generates an acid by irradiation of an ultraviolet ray and irradiating an ultraviolet ray to attain curing. Examples of the cationic polymerizable compound include compounds containing a ring opening-polymerizable group such as epoxy group and compounds containing a vinyl ether group.

For the support used in the present invention, a mixture of two or more kinds of resins selected from each type of the aforementioned thermosetting resins and radiation curable resins may be used, and a thermosetting resin and a radiation curable resin may be used together. Further, a mixture of a curable resin (crosslinkable resin) and a resin not having a crosslinkable group may also be used.

The aforementioned curable resin (crosslinkable resin) is preferably mixed in the support used in the present invention, because solvent resistance, heat resistance, optical characteristics, and toughness of the support can be thereby obtained. Moreover, it is also possible to introduce crosslinkable groups into a resin used for the support, and such a resin may have the crosslinkable group at any of end of polymer main chain, positions in polymer side chain and polymer main chain. When such a resin is used, the support may be prepared without using the aforementioned commonly used crosslinkable resin together.

When the gas barrier film of the present invention is used for liquid crystal displays and so forth, it is preferable to use an amorphous polymer as the polymer used in order to attain optical uniformity. Furthermore, for the purpose of controlling retardation (Re) and wavelength dispersion thereof, polymers having positive and negative intrinsic birefringences may be combined, or a resin showing a larger (or smaller) wavelength dispersion may be combined.

In the present invention, a laminate of different resins or the like may be preferably used as the support in order to control retardation (Re) or improve gas permeability and mechanical characteristics. No particular limitation is imposed on preferred combinations of different resins, and any combinations of the aforementioned resins can be used.

The support used in the present invention may be contain a resin property modifier such as plasticizers, dyes and pigments, antistatic agents, ultraviolet absorbers, antioxidants, inorganic microparticles, release accelerators, leveling agents, inorganic layered silicate compounds and lubricants as required in such a degree that the advantages of the present invention are not degraded.

The support used in the present invention may be stretched. Stretching provides advantages of improvement of mechanical strengths of the film such as anti-folding strength, and thus provides improvement of handling property of the support. In particular, a support having an orientation release stress (ASTM D1504, henceforth abbreviated as “ORS”) of 0.3 to 3 GPa along the stretching direction is preferred, because mechanical strength of such a support is improved. ORS is internal stress present in a stretched film or sheet generated by stretching.

Known methods can be used as the stretching method, and the stretching can be performed by, for example, monoaxial stretching method by roller, monoaxial stretching method by tenter, simultaneous biaxial stretching method, sequential biaxial stretching method or inflation method at a temperature of from a temperature higher than Tg of the resin by 10° C. to a temperature higher than Tg by 50° C. The stretching ratio is preferably 1.1 to 3.5 times.

Although the thickness of the support used in the present invention is not particularly limited, it is preferably 30 to 700 μm, more preferably 40 to 200 μm, still more preferably 50 to 150 μm. The haze of the support is preferably 3% or less, more preferably 2% or less, still more preferably 1% or less. Further, the total light transmission of the support is preferably 70% or more, more preferably 80% or more, still more preferably 90% or more.

The support used in the present invention can be produced by several kinds of techniques. Specific examples include a method of preparing a support by dissolving a resin in a solvent to obtain a solution, then coating and drying the solution, a method of preparing a support by kneading a polymer in a fused state and then forming a film from the polymer using an fusion extruder, and so forth. Both ends of the obtained support may be trimmed and knurled. As conditions used for the production of the support such as type of the solvent, conditions for casting, drying and so forth, known conditions may be used.

<Barrier Layer>

In the gas barrier film of the present invention, the material of the barrier layer is not particularly limited, and for example, oxides, nitrides, oxynitrides etc. containing one or more kinds of elements selected from Si, Al, In, Sn, Zn, Ti, Cu, Ce, Ta and so forth can be used.

Although the barrier layer may be formed by any method so long as a method that can form an objective desired thin film is chosen, the sputtering method, vacuum deposition method, ion plating method, plasma CVD method and so forth are suitable, and the film formation is preferably attained by, for example, the methods described in Japanese Patent No. 3400324, Japanese Patent Laid-open Pub-ication Nos. 2002-322561 and 2002-361774.

The thickness of the barrier layer is not also particularly limited. However, when it is too large, cracks may be generated by bending stress, and when it is too small, the film may be distributed in a dot pattern. In the both cases, water vapor barrier property tends to be degraded. From this viewpoint, the thickness of the barrier layer is preferably in the range of 5 to 1000 nm, more preferably 10 to 1000 nm, particularly preferably 10 to 200 nm.

Further, when two or more barrier layers are contained, they may have the same composition or different compositions.

In order to obtain both of water vapor barrier property and high transparency, it is preferable to use a metal compound thin layer comprising silicon oxide or silicon oxynitride as the barrier layer. Silicon oxide is represented as SiOₓ. For example, when SiOₓ is used for the inorganic substance layer, x is desirably more than 1.6 and less then 1.9 (1.6<x<1.9) in order to obtain both of favorable water vapor barrier property and high light transmission. Silicon oxynitride is represented as SiOₓN_{y}. As for the ratio of x and y, when improvement of adhesion property is emphasized, an oxygen rich film is preferred, and thus it is preferred that x is more than 1 and less than 2, and y is more than 0 and less than 1 (1<x<2, 0<y<1). When improvement of water vapor barrier property is emphasized, a nitrogen rich film is preferred, and thus it is preferred that x is more than 0 and less than 0.8, and y is more than 0.8 and less than 1.3 (0<x<0.8, 0.8<y<1.3).

<Organic Layer>

In the gas barrier film of the present invention, an organic layer is provided as a layer adjacent to the barrier layer for the purpose of improving brittleness and the barrier property of the aforementioned barrier layer. The organic layer can be formed by using (1) a method of utilizing an inorganic oxide layer prepared by using a sol-gel method, or (2) a method of coating or vapor-depositing an organic substance to form a layer and then curing the layer with an ultraviolet ray or electron beam. Further, the methods of (1) and (2) can be used in combination for the formation of the organic layer. For example, it is possible to form an organic layer on a resin film by the method of (1), then form a barrier layer, and further form a second organic layer by the method of (2).

(1) Sol-Gel Method

In the sol-gel method used in the present invention, a metal alkoxide is hydrolyzed and polycondensed preferably in a solution or coated film to obtain a dense thin film. In this operation, a resin may also be used together to obtain an organic/inorganic hybrid material.

As the metal alkoxide, alkoxysilanes and metal alkoxides other than alkoxysilane can be used. As the metal alkoxides other than alkoxysilane, zirconium alkoxides, titanium alkoxides, aluminum alkoxides and so forth are preferably used.

The polymer used in combination for the sol-gel reaction preferably has a hydrogen bond-forming group. Examples of resins having a hydrogen bond-forming group include polymers having hydroxyl group and derivatives thereof (polyvinyl alcohols, polyvinyl acetals, ethylene/vinyl alcohol copolymers, phenol resins, methylol melamines etc. and derivatives thereof); polymers having carboxyl group and derivatives thereof (homopolymers or copolymers containing units of a polymerizable unsaturated acid such as poly (meth)acrylic acids, maleic anhydride and itaconic acid, esters of these polymers (homopolymers or copolymers containing units of a vinyl ester such as vinyl acetate, (meth)acrylic acid ester such as methyl methacrylate or the like) etc.); polymers having an ether bond (polyalkylene oxides, polyoxyalkylene glycols, polyvinyl ethers, silicon resins etc.); polymers having an amide bond (N-acylated polyoxazolines and polyalkyleneimines having a >N(COR)— bond (in the formula, R represents hydrogen atom, an alkyl group which may be substituted or an aryl group which may be substituted)); polyvinylpyrrolidines having a >NC(O)— bond and derivatives thereof; polyurethanes having a urethane bond; polymers having a urea bond and so forth.

Further, monomers may be used together in the sol-gel reaction and polymerized during the sol-gel reaction or thereafter to produce an organic-inorganic hybrid material.

During the sol-gel reaction, the metal alkoxide is hydrolyzed and polycondensed in water or an organic solvent. For this reaction, it is preferable to use a catalyst. As the catalyst for hydrolysis, an acid (inorganic acid or organic acid) is generally used.

The amount of the acid used is 0.0001 to 0.05 mol, preferably 0.001 to 0.01 mol, per 1 mol of metal alkoxide (alkoxysilane+other metal alkoxide when alkoxysilane and other metal alkoxide are contained).

After the hydrolysis, a basic compound such as inorganic bases and amines may be added to adjust pH of the solution to make it close to neutral so that condensation polymerization should be promoted. Further, other sol-gel catalysts, for example, metal chelate compounds having Al, Ti or Zr as a center metal, organic metal compounds such as tin compounds, metal salts such as alkali metal salts of organic acids and so forth can also be used in combination.

The content of the sol-gel catalyst compound in the sol-gel reaction composition is 0.01 to 50% by weight, preferably 0.1 to 50% by weight, more preferably 0.5 to 10% by weight, based on the alkoxysilane as a raw material of the sol solution.

Solvents used in the sol-gel reaction will be explained below. The solvents allow all ingredients in the sol solution to be uniformly mixed, thereby make it possible to prepare solid matter in the composition of the present invention and use various coating methods, and improve dispersion stability and storage stability of the composition. These solvents are not particularly limited so long as they can achieve the aforementioned objects. Preferred examples of the solvents include, for example, water and organic solvents showing high water-miscibility.

In order to control the sol-gel reaction rate, organic compounds that can constitute multidentate ligands may be added to stabilize the metal alkoxide. Examples thereof include ,,-diketones and/or ,,-ketoesters and alkanolamines. Specific examples of the ,,-diketones and/or ,,-ketoesters include acetylacetone, methyl acetoacetate, ethyl acetoacetate, n-propyl acetoacetate, isopropyl acetoacetate, n-butyl acetoacetate, sec-butyl acetoacetate, tert-butyl acetoacetate, 2,4-hexanedione, 2,4-heptanedione, 3,5-heptanedione, 2,4-octanedione, 2,4-nonanedione, 5-methylhexanedione and so forth. Among these, ethyl acetoacetate and acetylacetone are preferred, and acetylacetone is particularly preferred. One kind of these ,,-diketones and/or ,,-ketoesters can solely be used, or two or more kinds of these can be used as a mixture.

When the aforementioned metal chelate compounds are used as sol-gel catalysts, these compounds that can be multidentate ligands can also be used to adjust the reaction rate.

A method for coating a sol-gel reaction composition will be described below. A sol solution can be used to form a thin film on a transparent film by using a coating method such as curtain flow coating, dip coating, spin coating or roller coating. The timing of hydrolysis may be at any time during the production process. For example, there can be preferably used a method in which a solution having a required composition is hydrolyzed and partially condensed to prepare a desired sol solution beforehand, and then it is applied and dried, a method in which a solution having a required composition is prepared, applied and dried while allowing the hydrolysis and partial condensation at the same time, a method in which, after a solution is coated and primarily dried, a water-containing solution necessary for hydrolysis is overlaid to attain the hydrolysis, and so forth. Further, various application methods can be used. When productivity is emphasized, a method in which the discharge flow rates of a lower layer coating solution and an upper layer coating solution are adjusted in a slide geeser having multiple discharge ports so that required coating amounts of the solutions should be obtained, and the formed multilayer flows are continuously placed on a support and dried (simultaneous multilayer coating method) is preferably used.

The temperature for drying in the aforementioned operations is 150 to 350° C., preferably 150 to 250° C., more preferably 150 to 200° C.

In order to make the organic layer further denser after the coating and drying, an energy beam may be irradiated on the organic layer. Although type of the irradiation beam is not particularly limited, irradiation of ultraviolet rays, electron beams or microwaves can be preferably used in view of influence on deformation and degeneration of the support. The irradiation intensity is 30 to 500 mJ/cm², particularly preferably 50 to 400 mJ/cm². The irradiation temperature may be selected from the range of from room temperature to the deformation temperature of the support without any particular limitation, and it is preferably 30 to 150° C., more preferably 50 to 130° C.

(2) Method of Coating or Vapor-Depositing an Organic Substance to Form a Layer and then Curing the Layer with an Ultraviolet Ray or Electron Beam

Hereafter, use of an organic layer formed with a polymer obtained by crosslinking monomers as a main component will be explained. Although the monomers are not particularly limited so long as they have a group that can be crosslinked with an ultraviolet ray or electron beam, monomers having acryloyl group, methacryloyl group or oxetane group are preferably used.

As for such monomers, it is preferable to use, as a main component, for example, polymers obtained by crosslinking monomers of bifunctionality or higher functionality having acryloyl group or methacryloyl group such as epoxy (meth)acrylate, urethane (meth)acrylate, isocyanurate (meth)acrylate, pentaerythritol (meth)acrylate, trimethylolpropane (meth)acrylate, ethylene glycol (meth)acrylate, and polyester (meth)acrylate. A mixture of two or more kinds of these monomers of bifunctionality or higher functionality having acryloyl group or methacryloyl group may be used, or a monofunctional (meth)acrylate may be mixed and used.

As for the monomers having oxetane group, those described in Japanese Patent Laid-open Publication No. 2002-356607, which have the structures represented by the following formulas (I) to (IV), are preferably used. Arbitrary mixtures of these monomers may also be used.

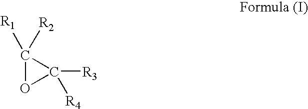

In the formula (I), R₁ to R₄ independently represent hydrogen atom or a hydrocarbon group which may be substituted, and R₁ and R₃ may bond to form an aliphatic cyclic group (preferably cyclohexane ring or cyclopentane ring) together with the carbon atoms to which these groups bond. As the hydrocarbon group, an alkyl group or aryl group having 1 to 36 carbon atoms is preferred, an alkyl group or aryl group having 1 to 24 carbon atoms is more preferred, and phenyl group and naphthyl group are preferred as the aryl group. As the substituent of the hydrocarbon group, arbitrary substituents may be allowed so long as a substituent that does not inhibit cationic polymerization is chosen, and a substituent that does not adversely affect cationic polymerization is preferred. Examples of the substituent of the aforementioned alkyl group include an alkoxyl group having 1 to 12 carbon atoms, an acyloxy group having 2 to 12 carbon atoms, an alkoxycarbonyl group having 2 to 12 carbon atoms, phenyl group, benzyl group, benzoyl group, benzoyloxy group, a halogen atom, cyano group, nitro group, phenylthio group, hydroxy group and triethoxysilyl group. Examples of the substituent of the aforementioned aryl group include an alkyl group having 1 to 12 carbon atoms, an alkoxyl group having 1 to 12 carbon atoms, an acyloxy group having 2 to 12 carbon atoms, an alkoxycarbonyl group, phenyl group, benzyl group, benzoyl group, benzoyloxy group, a halogen atom, cyano group, nitro group, phenylthio group, hydroxy group, and triethoxysilyl group.

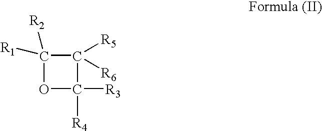

In the formula (II), R₁ to R₆ independently represent hydrogen atom or a hydrocarbon group which may be substituted. As the hydrocarbon group, an alkyl group or aryl group having 1 to 36 carbon atoms is preferred, an alkyl group or aryl group having 1 to 24 carbon atoms is more preferred, and phenyl group and naphthyl group are preferred as the aryl group. As the substituent of the hydrocarbon group, arbitrary substituents may be allowed so long as a substituent that does not inhibit cationic polymerization is chosen, and a substituent that does not adversely affect cationic polymerization is preferred. Examples of the substituent allowed for the hydrocarbon group include the same substituents as those exemplified as substituents of the alkyl group or aryl group represented by R₁ to R₄ in the formula (I).

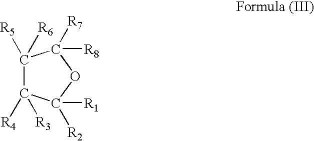

In the formula (III), R₁ to R₈ independently represent hydrogen atom or a hydrocarbon group which may be substituted. As the hydrocarbon group, an alkyl group or aryl group having 1 to 36 carbon atoms is preferred, an alkyl group or aryl group having 1 to 24 carbon atoms is more preferred, and phenyl group and naphthyl group are preferred as the aryl group. As the substituent of the hydrocarbon group, arbitrary substituents may be allowed so long as a substituent that does not inhibit cationic polymerization is chosen, and a substituent that does not adversely affect cationic polymerization is preferred. Examples of the substituent allowed for the hydrocarbon group include the same substituents as those exemplified as substituents of the alkyl group or aryl group represented by R₁ to R₄ in the formula (I).

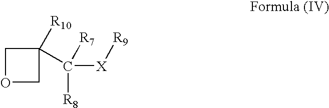

In the formula (IV), R₇, R₈ and R₁₀ independently represent hydrogen atom or an alkyl group which has 1 to 10 carbon atoms and may be substituted. R₉ represents a linear or branched alkyl group having 4 to 24 carbon atoms, and X represents oxygen atom. As R₉, an alkyl group which has 4 to 24 carbon atoms and may be substituted is preferred, and a linear or branched alkyl group which has 6 to 16 carbon atoms is more preferred. Examples of the substituent allowed for the alkyl group include the same substituents as those exemplified as substituents of the alkyl group represented by R₁ to R₄ in the formula (I).

Specific examples of the compound represented by the formula (IV) include OXT-212 wherein R₇ and R₈ are hydrogen atoms, R₁₀ is ethyl group, R₉ is 2-ethylhexyl group, and X is oxygen atom, OXR-12 represented by the following formula (V) (these are produced by Toagosei) and so forth.

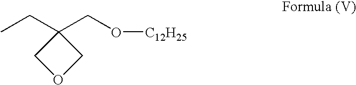

Although the irradiation intensity and irradiation temperature of electron ray or ultraviolet ray are not particularly limited, it is preferable to use the irradiation intensity and irradiation temperature mentioned for the method of (1) described above.

It is further preferable to use isocyanurate acrylate, epoxy acrylate or urethane acrylate, which shows a particularly high crosslinking degree and Tg of 200° C. or higher, as a main component in view of heat resistance and solvent resistance required for use in displays.

In the gas barrier film of the present invention, although the thickness of the organic layer is not particularly limited, it is preferably in the range of 10 nm to 5000 nm, more preferably 10 nm to 2000 nm. If the thickness of the organic layer is 10 nm or larger, an organic layer having a uniform thickness can be formed, and thus structural defects of the inorganic layer (barrier layer) can be efficiently filled with the organic layer. Therefore, the barrier property can be improved. Further, if the thickness of the organic layer is 5000 nm or smaller, cracks are not generated in the organic layer by an external force such as bending forth, and thus favorable gas barrier property can be maintained.

Examples of the method of forming the organic layer in the gas barrier film of the present invention include an application method, vacuum film formation method and so forth. Although the vacuum film formation method is not particularly limited, vapor deposition, plasma CVD and so forth are preferred, and the resistance heating vapor deposition method is more preferred, in which film formation rate of organic monomers is easily controlled. Although the method of crosslinking the organic monomers of the present invention is not limited at all, crosslinking by means of irradiation of active energy ray such as electron ray or ultraviolet ray is preferred for the reasons that equipment therefor is easily disposed in a vacuum chamber, and it rapidly provides a higher molecular weight by crosslinking reactions.

When the organic layer is formed by an application method, conventionally used various application methods such as roller coating, photogravure coating, knife coating, dip coating, curtain flow coating, spray coating and bar coating can be used.

The gas barrier film of the present invention comprises a laminate alternately having at least one barrier layer and at least one organic layer, and the laminate may be formed on one side of the support, or may be formed on the both sides. Moreover, two or more of the laminates may be directly and repeatedly stacked. When such repeating units are formed, the number of the units should be 5 or less, preferably 2 or less, in view of the gas barrier property, production efficiency and so forth. Further, when the repeating units are formed, the two or more of the inorganic layers and organic layers may have the same compositions or different compositions, respectively.

In the present invention, the aforementioned laminate preferably has a water vapor permeability of 0.005 g/m²·day or lower at 25° C. and 75% of relative humidity (RH). Further, the aforementioned laminate preferably has an oxygen permeability of 0.005 mL/m²·day·atm measured at 25° C. and 75% RH. If the gas barrier film having gas barrier performance within the aforementioned ranges is used in an organic EL device, degradation of the EL device by water vapor and oxygen can be substantially avoided. Therefore, the gas barrier performance defined above is preferred. The water vapor permeability can be measured by using a water vapor transmission rate system (water vapor permeability measurement apparatus), PERMATRAN produced by MOCON.

<Moisture Absorbing Layer>

The gas barrier film of the present invention has at least one moisture absorbing layer in addition to the aforementioned laminate. Because the gas barrier film of the present invention is provided with the moisture absorbing layer, it can absorb moisture existing in the external environment with the moisture absorbing layer and thus prevent invasion of moisture into the inside of the support.

The moisture absorbing agent constituting the moisture absorbing layer can be suitably chosen from compounds having an ability to absorb moisture, mainly consisting of alkaline earth metal compounds. The moisture absorbing agent preferably comprises, for example, at least one kind of compound selected from BaO, SrO, CaO and MgO. Further, the moisture absorbing agent can also be chosen from metallic elements such as Ti, Mg, Ba and Ca.

The particle size of the moisture absorbing agent is preferably 1 to 100 nm, more preferably 1 to 50 nm, still more preferably 1 to 10 nm, in terms of a diameter as sphere. The particle size of the moisture absorbing agent is 1 to 100 nm in terms of a diameter as sphere is preferred, because transparency can be maintained, and the amount of moisture absorption per unit weight increases with such a particle size.

The term “diameter as sphere” of moisture absorbing agent particle used herein means a diameter of sphere having the same volume as the particle.

The moisture absorbing layer may be prepared by the vacuum vapor depositing method or the like, like the barrier layer described above, or it may be prepared from nanoparticles by various kinds of methods.

Although thickness of the moisture absorbing layer is not particularly limited so long as it is more than the diameter of the moisture absorbing agent as sphere, it is preferably 1 to 100 nm, more preferably 1 to 50 nm, still more preferably 110 nm. If the thickness of the moisture absorbing layer is 1 to 100 nm, transparency can be maintained, and amount of moisture absorption per unit weight increases. Therefore, such a thickness is preferred.

The moisture absorbing layer preferably shows small change of thickness before and after moisture absorption. Change in the thickness of the moisture absorbing layer after moisture absorption is preferably 3 nm or less, more preferably 2 nm or less, still more preferably 1 nm or less. If the thickness change is 3 nm or less, short circuit is not caused, for example, when the gas barrier film is used in an organic EL device etc. Therefore, thickness change in such a range is preferred.

The charge in thickness of the moisture absorbing layer after moisture absorption can be measured by a non-contact type thickness profilometer (DEKTEK produced by ULVAC).

As for the position of the moisture absorbing layer, the moisture absorbing layer may be formed between the support and the laminate (organic layer+barrier layer), on the uppermost laminate, between laminates, in the organic layer or barrier layer of the laminate. When the moisture absorbing layer is provided as a layer also serving as the barrier layer, the thermal coevaporation method is preferably used.

Ir the gas barrier film of the present invention, known primer layer and inorganic thin film layer can be disposed between the support and the laminate, or between the support and the barrier layer or organic layer.

Although acrylic resins, epoxy resins, urethane resins, silicone resins and so forth, for example, can be used as the primer layer of the gas barrier layer of the present invention, it is preferable to form an organic-inorganic hybrid layer as the primer layer or an inorganic vapor-deposited layer or dense inorganic coated thin film prepared by the sol/gel method as the inorganic thin film layer. As the inorganic vapor-deposited layer, vapor-deposited layers of silica, zirconia, alumina and so forth are preferred. The inorganic vapor-deposited layer can be formed by the vacuum deposition method, sputtering method or the like.

In the gas barrier film of the present invention, various known functional layers may be provided or the laminate or as an outermost layer. Examples of the functional layers include optically functional layers such as anti-reflection layer, polarization layer, color filter, ultraviolet absorbing layer and light extraction efficiency improving layer, mechanically functional layers such as hard coat layer and stress relaxation layer, electrically functional layers such as antistatic layer and conductive layer, antifogging layer, antifouling layer, printable layer and so forth.

As a transparent conductive layer that can be formed in the gas barrier film of the present invention, known metal films and metal oxide films can be used. Metal oxide films are particularly preferred in view of transparency, conductivity and mechanical characteristics. Examples include, for example, metal oxide films such as those of indium oxide, cadmium oxide, and tin oxide added with tin, tellurium, cadmium, molybdenum, tungsten, fluorine or the like as impurities, zinc oxide, titanium oxide and so forth added with aluminum as impurities. In particular, thin films of indium oxide containing 2 to 15 weight % of tin oxide (ITO) have superior transparency and conductivity, and therefore they are preferably used. Examples of the method of forming the transparent conductive layer include the vacuum deposition method, sputtering method, ion beam sputtering method and so forth.

The film thickness of the transparent conductive layer is preferably in the range of 15 to 300 nm. If the film thickness of the transparent conductive layer is 15 nm or larger, the film can be a continuous film, and sufficient conductivity can be obtained. On the other hand, if it is 300 nm or smaller, favorable transparency can be maintained, and favorable flexibility can be obtained.

The transparent conductive layer may be provided either on the base material film (support) side or the gas barrier coat layer (laminate=organic layer+inorganic layer (barrier layer)) side so long as it is provided as an outermost layer. However, it is preferably provided on the gas barrier coat layer side in view of prevention of invasion of moisture contained in the base material film in a small amount.

In the gas barrier film of the present invention, one or more inorganic thin film layers and one or more gas barrier coat layers prepared by a sol-gel method as described above or defect compensating layers may be repeatedly provided on the laminate.

As the defect compensating layer provided adjacently to the laminate, (1) an inorganic oxide layer prepared by using a sol-gel method as disclosed in U.S. Pat. No. 6,171,663 and Japanese Patent Laid-open No. 2003-94572, or (2) an organic substance layer as disclosed in U.S. Pat. No. 6,413,645 can be used.

These defect compensating layers car be prepared by a method of depositing a layer by vacuum vapor deposition and then curing it with an ultraviolet ray or electron beam, or by coating a layer and then curing it with heating, electron beam, ultraviolet ray or the like. When the defect compensating layer is prepared by using coating, various conventionally used coating methods such as spray coating, spin coating and bar coating can be used.

[Image Display Device]

Although the use of the gas barrier film of the present invention is not particularly limited, it can be suitably used as a transparent electrode substrate of image d-splay device because of its superior optical characteristics and mechanical characteristics. The “image display device” referred to herein means a circularly polarizing plate, liquid crystal display device, touch panel, organic EL device or the like.

<Circularly Polarizing Plate>

A ,,/4 plate and a polarizing plate can be laminated on a conductive substrate obtained by forming a transparent conductive layer on the gas barrier film of the present invention (referred to simply as “conductive substrate” hereinafter) to prepare a circularly polarizing plate. In this case, they are laminated so that the angle formed by the lagging axis of the ,,/4 plate and the absorption axis of the polarizing plate should become 45°. As the polarizing plate, one stretched along a direction at an angle of 45′ with respect to the machine direction (MD) is preferably used, and for example, the one described in Japanese Patent Laid-open Publication No. 2002-865554 can be suitably used.

<Liquid Crystal Display Device>

A reflection type liquid crystal display device has, in the order from the bottom, a lower substrate, reflective electrode, lower oriented film, liquid crystal layer, upper oriented film, transparent electrode, upper substrate, ,,/4 plate and polarizing film. The gas barrier film of the present invention can be used in the aforementioned transparent electrode and upper substrate as a conductive substrate. In the case of a color display device, it is preferable to further provide a color filter layer between the reflective electrode and the lower oriented film or between the upper oriented film and the transparent electrode.

A transmission type liquid crystal display device has, in the order from the bottom, a back light, polarizing plate, ,,/4 plate, lower transparent electrode, lower oriented film, liquid crystal layer, upper oriented film, upper transparent electrode, upper substrate, ,,/4 plate and polarization film. Among these, the gas barrier film of the present invention can be used in the aforementioned upper transparent electrode and upper substrate as a conductive substrate. In the case of a color display device, it is preferable to further provide a color filter layer between the lower transparent electrode and the lower oriented film or between the upper oriented film and the transparent electrode.

Although type of liquid crystal cell is not particularly limited, more preferred are the TN (Twisted Nematic) type, STN (Supper Twisted Nematic) type, HAN (Hybrid Aligned Nematic) type, VA (Vertically Alignment) type, ECB (Electrically Controlled Birefringence) type, OCB (Optically Compensatory Bend) type and CPA (Continuous Pinwheel Alignment) type.

<Touch Panel>

As for touch panel, the gas barrier film of the present invention can be applied to those described in Japanese Patent Laid-open Publication Nos. 5-127822, 2002-48913 and so forth.

<Organic EL Device>

The gas barrier film of the present invention can be used for 6 organic EL devices. Specific examples of layer structure of organic EL display device include positive electrode/luminescent layer/transparent negative electrode, positive electrode/luminescent layer/electron transport layer/transparent negative electrode, positive electrode/hole transport layer/luminescent layer/electron transport layer/transparent negative electrode, positive electrode/hole transport layer/luminescent layer/transparent negative electrode, positive electrode/luminescent layer/electron transport layer/electron injection layer/transparent negative electrode, positive electrode/hole injection layer/hole transport layer/luminescent layer/electron transport layer/electron injection layer/transparent negative electrode and so forth.

When the gas barrier film of the present invention is used in an organic EL device, it is preferably used according to the disclosures of Japanese Patent Laid-open Publication Nos. 11-335661, 11-335368, 2001-192651, 2001-192652, 2001-192653, 2001-335776, 2001-247859, 2001-181616, 2001-181617, 2002-181816, 2002-181617 and 2002-056976 as well as those of Japanese Patent Laid-open Publication Nos. 2001-148291, 2001-221916 and 2001-231443.

That is, the gas barrier film of the invention can be used as a base material film and/or protective film used for forming organic EL devices.

### EXAMPLES

Hereafter, the present invention will be further specifically explained by referring to examples. However, the materials, amounts used, ratios, types of processes, order of processes and so forth mentioned in the examples may be optionally changed so long as such changes do not depart from the spirit of the present invention. Therefore, the scope of the present invention should not be construed in any limitative way on the basis of the following examples.

[Methods for Measuring Characteristic Values]

(1) Water Vapor Permeability

Water vapor permeability was measured by the MOCON method at 25° C. and 75% RH.

(2) Thickness Change of Water Absorbing Layer After Moisture Absorption

Thickness change of the water absorbing layer was measured by using DEKTEK (produced by ULVAC).

(3) Glass Transition Temperature (Tg)

Tg was measured by the DSC method using DSC 6200 produced by SEIKO CORP. (in nitrogen, temperature increasing rate: 10° C./minute). The measurement was performed under the following conditions.
Amount of sample; 20 mg
Temperature increasing rate: 10° C./minute
Measurement temperature region: 30 to 300° C.

At Tg, specific heat discontinuously charges, that is, Tg exist on the lower temperature side baseline, in the transition region (region in which Tg linearly changes from the lower temperature side baseline to the higher temperature side baseline) and then on the high temperature side baseline. In the present invention, a temperature corresponding to the intersection of the Lower temperature side baseline and a straight line extrapolating the transition region was considered as Tg.

### Example 1

1. Preparation of Support

Exemplary Compound (I-1) was dissolved in methylene chloride at a concentration of 15 weight % and cast on a stainless steel band by the die coating method. Subsequently, the first film was delaminated from the band and dried until the residual solvent concentration became 0.08 weight %. Then, the both ends of the film were trimmed and knurled, and the film was rolled up to prepare a plastic film having a thickness of 100 μm. Further, similar plastic films were prepared in the same manner except that the exemplary compound was changed to each of the compounds shown in Table 1.

2. Preparation of Barrier Layer

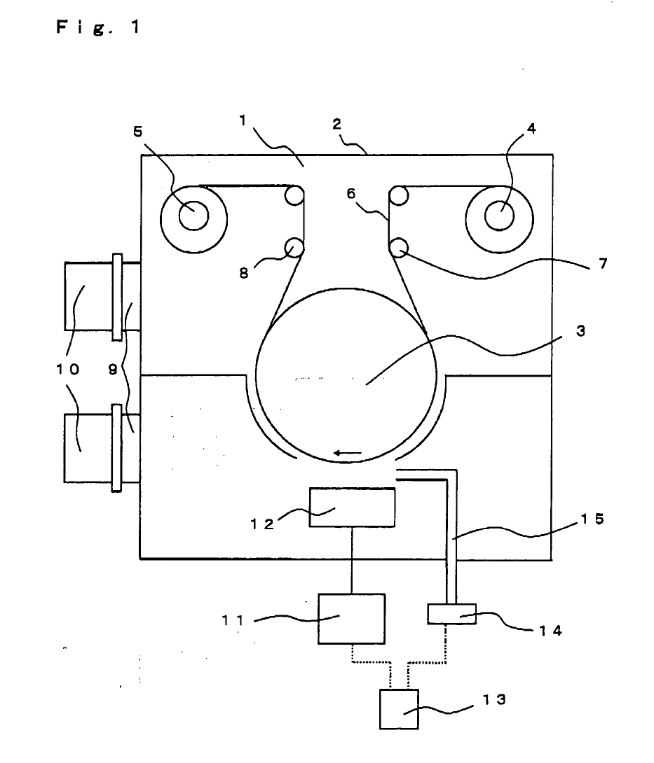

A roll-to-roll type sputtering apparatus shown in FIG. 1 was used. This apparatus had a vacuum chamber 2, and a drum 3 for cooling a support 6 by contact on the surface was disposed at the center of the chamber. Further, a feeding roller 4 and rolling-up roller 5 for winding the support 6 were disposed in the vacuum chamber 2. The support 6 wound around the feeding roller 4 was wound around the drum 3 via a guide roller 7, and further the support 6 was wound around a roller 5 via a guide roller 8. As for a vacuum pumping system, the gas in the vacuum chamber 2 was always evacuated by the vacuum pumps 10 from exhaust ports 9. As for a film formation system, a target (not shown) was placed on a cathode 12 connected to an electric discharge power source 11 of the direct current system, which could apply pulse electric power. This electric discharge power source 11 was connected to a controller 13, and this controller 13 was further connected to a gas flow control unit 14, which supplied reactive gas to the vacuum chamber 2 through a piping 15 while controlling the introduced gas volume. Further, the vacuum chamber 2 was designed so that an electric discharge gas could be supplied to the chamber at a constant flow rate (not shown). Hereafter, specific conditions will be explained.

Si was set as a target, and a DC power source of the pulse applying type was prepared as the electric discharge power source 11. As the support 6, a PET film and the films prepared by the method described above, which had a thickness of 100 μm, were used, and each film was put on the feeding roller 4, and led to the winding roller 5. After the preparation of the base material in the sputtering apparatus 1 was finished, a door of the vacuum chamber 2 was closed, and the vacuum pump was operated to start evacuation and cooling of the drum. When the reached pressure became 4×10⁻⁴ Pa, and the drum temperature became 5° C., running of the support 6 was started. Argon was introduced as the electric discharge gas, and the electric discharge power source 11 was turned on to generate plasma on the Si target at an electric discharge power of 5 kW and a film formation pressure of 0.3 Pa and thereby perform presputtering for 3 minutes. Then, oxygen was introduced as a reactive gas. After the discharge was stabilized, argon and oxygen gas volumes were gradually decreased to lower the film formation pressure to 0.1 Pa. After stability of the discharge at 0.1 Pa was confirmed, formation of a silicon oxide film was performed for a certain period of time. After completion of the film formation, the internal pressure of the vacuum chamber 2 was returned to the atmospheric pressure, and the film on which the silicon oxide film was formed was taken out.

3. Preparation of Laminate Film

(1) Lamination Method A

Five each of inorganic oxide layers and the aforementioned acrylate resin layers were laminated on each of the films shown in Table 1 by the method disclosed in International Patent Unexamined Publication in Japanese (Kohyo) No. 2002-532850.

(2) Lamination Method B

On each of the supports mentioned in Table 1, a barrier layer was prepared by using the sputtering apparatus 1 of the roll-to-roll type mentioned above. Then, a solution of tetraethylene glycol diacrylate, caprolactone acrylate and tripropylene glycol monoacrylate mixed at a weight ratio of 7:1.2:1.4 was added with 1 weight % of a radical initiator (Irgacure 651, produced by Ciba-Geigy), dissolved in a solvent, coated on a support of polyethersulphone having a thickness of 0.1 mm, dried and then cured by UV irradiation to prepare a compensating organic layer having a thickness of about 2 μm on the support. These procedures were repeated to alternately laminate five each of barrier layers and organic layers.

(3) Lamination Method C

On each of the supports mentioned in Table 1, a coating composition comprising 100 parts (weight parts, the same shall apply to the term “part(s)” used hereinafter) of di [1-ethyl(3-oxetanyl)]methyl ether (OXT-221 produced by Toagosei) and 2 parts of diphenyl-4-thiophenoxysulfonium hexafluoroantimonate as a polymerization initiator was coated by bar coating with a coated thickness of about 4 μm to prepare base materials. The base materials were irradiated with an ultraviolet ray at an irradiation intensity of 70 mJ/cm² in the atmosphere by using an ultraviolet ray irradiation apparatus (TOSCURE 401 produced by Harison Toshiba Lighting Corp.) using a high-pressure mercury lamp of 395 W. The curing was attained by ultraviolet ray irradiation at such an irradiation intensity that the composition should react sufficiently (2000 mJ/cm², confirmed by FT-IR). These procedures were repeated to alternately laminate five each of barrier layers and organic layers.

(4) Lamination Method D

On each of the supports mentioned in Table 1, a barrier layer was formed in the same manner as in Lamination method B. In an amount of 8 g of SOARNOL D2908 (ethylene/vinyl alcohol copolymer produced by Nippon Synthetic Chemical Industry) was dissolved in a mixed solvent of 118.8 g of 1-propanol and 73.2 g of water at 80° C. In an amount of 10.72 g of this solution was added and mixed with 2.4 ml of 2 M/L (N) hydrochloric acid. This solution was added dropwise with 1 g of tetraethoxysilane with stirring and further stirred for 30 minutes. Then, the obtained coating solution was added with dimethylbenzylamine for pH adjustment immediately before application and applied to the aforementioned barrier layer formed on each support by using a wire bar. Then, the coated layer was dried at 120° C. to form a sol-gel layer having a film thickness of about 1 ,,m. These procedures were repeated to alternately laminate five each of barrier layers and sol-gel layers.

(5) Lamination Method E

In the same manner as Lamination method A except that the lamination was performed once for each layer, one each of the inorganic oxide layer and the aforementioned acrylate resin layer were laminated.

(6) Lamination Method F

In the same manner as Lamination method D except that the lamination was performed once for each layer, one each of the barrier layer and the sol-gel layer were laminated.

4. Preparation of Moisture Absorbing Layer

On each of the aforementioned laminate, a layer of calcium oxide nanoparticles (produced by Nanophase Technologies, particle diameter: 50 nm) was laminated with a thickness of 3 nm. A moisture absorbing layer produced by vapor deposition of Ca in an oxygen atmosphere also provided the same effect.

Water vapor permeability of the gas barrier films 1 to 15 obtained by the aforementioned methods was measured by the MOCON method at 25° C. and 75% RH. The results are shown in Table 1.

TABLE 1

| | | | | | | Thickness | |
|---|---|---|---|---|---|---|---|
| | | | | | | change of | |
| | | | | | | moisture | |
| Gas | | | | Water | Water vapor | absorbing | |
| barrier | | Tg | Lamination | absorbing | permeability | layer | |
| film | Support | (° C.) | method | agent | (g/m² · day) | (nm) | Note |
| 1 | PES | 220 | A | x | <0.005 | — | Comparative 1 |
| 2 | PES | 220 | A | ∘ | <0.005 | 1.5 | Invention 1 |
| 3 | PES | 220 | B | ∘ | <0.005 | 1.5 | Invention 2 |
| 4 | PES | 220 | C | ∘ | <0.005 | 1.2 | Invention 3 |
| 5 | PES | 220 | A | ∘ | <0.005 | 1.6 | Invention 4 |
| 6 | I-1 | 250 | A | ∘ | <0.005 | 1.5 | Invention 5 |
| 7 | C-5 | 263 | A | ∘ | <0.005 | 1.5 | Invention 6 |
| 8 | F-3 | 258 | A | ∘ | <0.005 | 1.5 | Invention 7 |
| 9 | H-8 | 246 | A | ∘ | <0.005 | 1.5 | Invention 8 |
| 10 | FL-1 | 350 | A | ∘ | <0.005 | 1.5 | Invention 9 |
| 11 | FL-1 | 350 | B | ∘ | <0.005 | 1.2 | Invention 10 |
| 12 | FL-1 | 350 | C | ∘ | <0.005 | 1.6 | Invention 11 |
| 13 | FL-1 | 350 | D | ∘ | <0.005 | 1.6 | Invention 12 |
| 14 | PES | 220 | E | x | 0.46 | — | Comparative 2 |
| 15 | PES | 220 | F | x | 0.30 | — | Comparative 3 |
| 16 | PES | 220 | E | ∘ | 0.46 | 3.8 | Comparative 4 |
| 17 | PES | 220 | F | ∘ | 0.80 | 3.8 | Comparative 5 |
| 18 | PET | 90 | A | ∘ | <0.005 | 2.5 | Invention 13 |

As shown in Table 1, all of the gas barrier films of the present invention (Films 2 to 13 and 18) showed ultrahigh gas barrier performance as represented by water vapor permeability lower than 0.005 g/m²·day. From these results, it was found that the gas barrier films of the present invention showed ultrahigh gas barrier property comparable to, for example, that of the conventional gas barrier film disclosed in International Patent Unexamined Publication in Japanese No. 2002-532850.

On the other hand, it can be seen that when the moisture absorbing layer was not formed (Films 1, 14 and 15), the water vapor permeability exceeded 0.005 g/m²·day, that is, gas barrier property better than that of the gas barrier films of the present invention could not be obtained.

### Example 2

Preparation of Organic EL Devices

Each of the aforementioned films was introduced into a vacuum chamber, and a transparent electrode composed of an IXO thin film having a thickness of 0.2 ,,m was formed by DC magnetron sputtering using an IXO target. An aluminum lead wire was connected to the transparent electrode (IXO) to form a laminated structure. An aqueous dispersion of polyethylene dioxythiophene/polystyrenesulfonic acid (Baytron P, BAYER, solid content: 1.3 weight %) was applied on the surface of the transparent electrode by spin coating and then vacuum-dried at 150° C. for 2 hours to form a hole transporting organic thin film layer having a thickness of 100 nm. This was designated Substrate X.

Further, a coating solution for light-emitting organic thin film layer having the following composition was applied on one side of a temporary support made of polyethersulfone having a thickness of 188 ,,m (SUMILITE FS-1300, Sumitomo Bakelite) by using a spin coater and dried at room temperature to form a light-emitting organic thin film layer having a thickness of 13 nm on the temporary support. This was designated Transfer Material Y.

| | |
|---|---|
| Polyvinyl carbazole | 40 parts by weight |
| (Mw = 63000, Aldrich) | |
| Tris(2-phenylpyridine) iridium | 1 part by weight |
| complex (Ortho-metalated complex) | |
| Dichloroethane | 3200 parts by weight |

The light-emitting organic thin film layer side of Transfer Material Y was overlaid on the upper surface of the organic thin film layer of Substrate X, heated and pressurized under the conditions of 160° C., 0.3 MPa and 0.05 m/min by using a pair of heat rollers, and the temporary support was delaminated to form a light-emitting organic thin film layer on the upper surface of Substrate X. This was designated Substrate XY.

Further, a patterned mask for vapor deposition (mask providing a light-emitting area of 5 mm×5 mm) was set on one side of a polyimide film (UPILEX-50S, Ube Industries) cut into a 25-mm square and having a thickness of 50 ,,m, and Al was vapor-deposited in a reduced pressure atmosphere of about 0.1 mPa to form an electrode having a film thickness of 0.3 ,,m. Al₂O₃ was vapor-deposited by DC magnetron sputtering using an Al₂O₃ target with a film thickness of 3 nm in the same pattern as the Al layer. An aluminum lead wire was connected to the Al electrode to form a laminated structure. A coating solution for electron transporting organic thin film layer having the following composition was applied on the obtained laminated structure by using a spin coater and vacuum-dried at 80° C. for 2 hours to form an electron transporting organic thin film layer having a thickness of 15 nm on Al₂O₃. This was designated Substrate Z.

| | | |
|---|---|---|
| Polyvinyl butyral | 10 | parts by weight |
| (2000L produced by Denki | | |
| Kagaku Kogyo, Mw = 2000,) | | |
| Electron transporting compound | 20 | parts by weight |
| having the following structure | | |

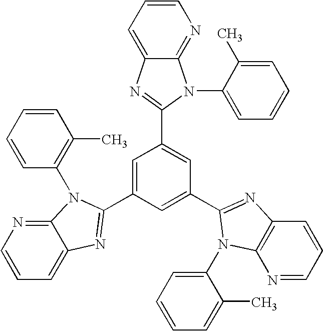

| | | |
|---|---|---|
| 1-Butanol | 3500 | parts by weight |

Substrate XY and Substrate Z were stacked so that the electrodes should face each other via the light-emitting organic thin film layer between them, heated and pressurized at 160° C., 0.3 MPa and 0.05 m/min by using a pair of heat rollers to obtain Organic EL Devices 1 to 18.

DC voltage was applied to the obtained Organic EL Devices 1 to 18 by using Source-Measure Unit Model 2400 (Toyo Corporation) to allow them to emit light. All of the devices favorably emitted light.

After the production of Organic EL Devices 1 to 18, they were left in an environment of 25° C. and 75% RH for 1 month. Then, they were allowed to emit light in the same manner, and ratio of light emitting portion relative to the total area (non-light emitting portion consisted of dark spots) was obtained by using a microanalyzer produced by Nihon Poladigital. The results are shown in Table 2.

TABLE 2

| | | | | | Thickness | | |
|---|---|---|---|---|---|---|---|
| | | | | | change of | | |
| | | | | | moisture | | |
| | | | Water | Water vapor | absorbing | Dark | |
| | | Lamination | absorbing | permeability | layer | spot | |
| Device | Support | method | agent | (g/m² · day) | (nm) | (%) | Note |
| 1 | PES | A | x | <0.005 | — | 68 | Comparative 1 |
| 2 | PES | A | ∘ | <0.005 | 1.5 | 88 | Invention 1 |
| 3 | PES | B | ∘ | <0.005 | 1.5 | 90 | Invention 2 |
| 4 | PES | C | ∘ | <0.005 | 1.5 | 92 | Invention 3 |
| 5 | PES | A | ∘ | <0.005 | 1.5 | 98 | Invention 4 |
| 6 | I-1 | A | ∘ | <0.005 | 1.5 | 99 | Invention 5 |
| 7 | C-5 | A | ∘ | <0.005 | 1.5 | 96 | Invention 6 |
| 8 | F-3 | A | ∘ | <0.005 | 1.5 | 95 | Invention 7 |
| 9 | H-8 | A | ∘ | <0.005 | 1.5 | 96 | Invention 8 |
| 10 | FL-1 | A | ∘ | <0.005 | 1.5 | 94 | Invention 9 |
| 11 | FL-1 | B | ∘ | <0.005 | 1.2 | 97 | Invention 10 |
| 12 | FL-1 | C | ∘ | <0.005 | 1.2 | 97 | Invention 11 |
| 13 | FL-1 | D | ∘ | <0.005 | 1.1 | 95 | Invention 12 |
| 14 | PES | E | x | 0.46 | — | 0 | Comparative 2 |
| 15 | PES | F | x | 0.30 | — | 3 | Comparative 3 |
| 16 | PES | E | ∘ | 0.46 | 1.5 | 5 | Comparative 4 |
| 17 | PES | F | ∘ | 0.30 | 1.6 | 10 | Comparative 5 |
| 18 | PET | A | ∘ | <0.005 | 2.8 | 78 | Invention 13 |

From the results shown ir Table 2, it can be seen that the organic EL devices utilizing the gas barrier films of the present invention (Devices 2 to 13 and 18) showed superior durability and showed favorable light emission ever after they were left in a high humidity environment for one month. It can also be seen that, or the other hand, all of the organic EL devices for which the moisture absorbing layer was not formed showed poor durability and degradation of light emission in a high humidity environment.

### Example 3

Gas barrier films 19 to 21 were formed in the same manner as used in Example 1 except that strontium oxide, magnesium oxide and barium oxide having a diameter of 50 nm as sphere were used instead of the calcium oxide used in the moisture absorbing layer, and Lamination method A was used, and water vapor permeability and thickness change of the moisture absorbing layer of the films were measured.

Then, Organic EL devices 19 to 21 were produced in the same manner as in Example 2, and dark spots (%) were measured.

All of Films 19 to 21 showed a water vapor permeability lower than 0.005 g/m²·day. Further, Films 19 to 21 showed moisture absorbing layer thickness changes of 1.0 nm, 1.4 nm and 1.4 nm, respectively.

The dark spots of Organic EL devices 19 to 21 accounted for 92%, 94% and 94%, respectively.

The gas barrier film of the present invention has superior gas barrier performance, and therefore it can be suitably used as a substrate of various devices or as a material suitable for coating a substrate in image display devices such as organic EL devices.

The present disclosure relates to the subject matter contained in Japanese Patent Application No. 039324/2004 filed on Feb. 17, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A gas barrier film having (1) a laminate alternately comprising at least one barrier layer comprising an inorganic substance and at least one organic layer and (2) at least one moisture absorbing layer on a thermoplastic support, wherein the laminate shows a water vapor permeability of 0.005 g/m²·day or lower at 25° C. and 75% RH.

2. The gas barrier film according to claim 1, wherein the moisture absorbing layer comprises at least one kind of metal compound selected from the group consisting of CaO, SrO, BaO and MgO.

3. The gas barrier film according to claim 2, wherein the metal compound has a diameter of 1 to 100 nm as sphere.

4. The gas barrier film according to claim 1, wherein the moisture absorbing layer comprises at least one kind of metal element selected from the group consisting of Ti, Mg, Ba and Ca.

5. The gas barrier film according to claim 1, wherein the moisture absorbing layer is formed by the vacuum vapor depositing method.

6. The gas barrier film according to claim 1, wherein the moisture absorbing layer has a thickness of 1 to 100 nm.

7. The gas barrier film according to claim 1, wherein the moisture absorbing layer has a thickness of 1 to 10 nm.

8. The gas barrier film according to claim 1, wherein the moisture absorbing layer shows a thickness charge of 3 nm or less after moisture absorption.

9. The gas barrier film according to claim 1, wherein the moisture absorbing layer is formed on the laminate.

10. The gas barrier film according to claim 1, wherein the thermoplastic support is formed with a polymer having a glass transition temperature of 250° C. or higher.

11. The gas barrier film according to claim 1, wherein the thermoplastic support comprises an aromatic polyester.

12. The gas barrier film according to claim 1, wherein the thermoplastic support comprises a polymer having a structure represented by the following formula (1): 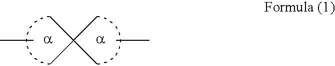
wherein the rings ,, represent a monocyclic or polycyclic ring, and two of the rings may be identical or different and are bound via a spiro bond.

13. The gas barrier film according to claim 1, wherein the thermoplastic support comprises a polymer having a structure represented by the following formula (2): 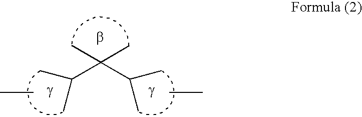
wherein the ring ,, and the rings ,, each independently represent a monocyclic or polycyclic ring, and two of the rings ,, may be identical or different and bond to one quaternary carbon atom in the ring ,,.

14. The gas barrier film according to claim 1, wherein the thermoplastic support comprises a polymer having a structure represented by the following formula (3): 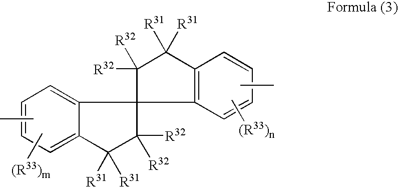
wherein R³¹ and R³² each independently represent hydrogen atom or a substituent and R³³ represents a substituent. Groups of each type may bond to each other to form a ring. m and n each independently represent an integer of 0 to 3.

15. The gas barrier film according to claim 1, wherein the thermoplastic support comprises a polymer having a structure represented by the following formula (4): 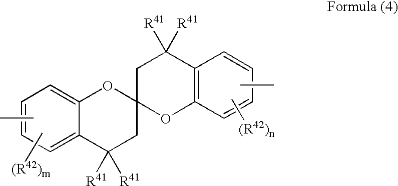
wherein R⁴¹ represents hydrogen atom or a substituent and R⁴² represents a substituent. Groups of each type may bond to each other to form a ring. m and n each independently represent an integer of 0 to 3.

16. The gas barrier film according to claim 1, wherein the thermoplastic support comprises a polymer having a structure represented by the following formula (5): 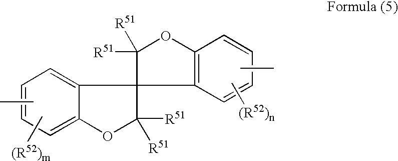
wherein R⁵¹ represents hydrogen atom or a substituent and R⁵² represents a substituent. Groups of each type may bond to each other to form a ring. m and n each independently represent an integer of 0 to 3.

17. The gas barrier film according to claim 1, wherein the thermoplastic support comprises a polymer having a structure represented by the following formula (6): 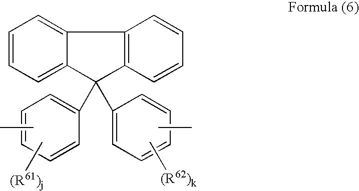
wherein R⁶¹ and R⁶² each independently represent a substituent. Groups of each type may bond to each other to form a ring. j and k each independently represent an integer of 0 to 4.

18. The gas barrier film according to claim 1, wherein the organic layer is an organic-inorganic hybrid layer.

19. The gas barrier film according to claim 1, wherein the organic layer is a layer obtained by ring-opening polymerization of monomers having an oxetane group.

20. An organic electroluminescence device, which utilizes the gas barrier film according to claim 1 as a substrate.
